(19) United States
(12) Patent Application Publication
(10) Pub. No.: US 2019/0027752 A1
(43) Pub. Date: Jan. 24, 2019

(54) NON-AQUEOUS ELECTROLYTE SECONDARY BATTERY

(71) Applicant: Panasonic Intellectual Property Management Co., Ltd., Osaka (JP)

(72) Inventors: Ryo Kazama, Hyogo (JP); Masanobu Takeuchi, Osaka (JP); Tomoki Tsuji, Osaka (JP); Manabu Takijiri, Osaka (JP)

(73) Assignee: Panasonic Intellectual Property Management Co., Ltd., Osaka (JP)

(21) Appl. No.: 16/141,272

(22) Filed: Sep. 25, 2018

Related U.S. Application Data
(63) Continuation of application No. PCT/JP2017/004485, filed on Feb. 8, 2017.

(30) Foreign Application Priority Data
Mar. 31, 2016 (JP) 2016-071014

(51) Int. Cl. H01M 4/525; H01M 10/05; H01M 4/505

(52) U.S. Cl. CPC H01M 4/525; H01M 2004/028; H01M 4/505; H01M 10/05

(57) ABSTRACT

This non-aqueous electrolyte secondary battery is equipped with a positive electrode comprising: a positive electrode active substance containing a lithium-containing transition metal oxide; and a lithium compound derived from an irreversible substance irreversibly reacting with lithium at a voltage lower than the average operating voltage of the positive electrode active substance.

### TECHNICAL FIELD

The present disclosure relates to a non-aqueous electrolyte secondary battery.

### BACKGROUND ART

A non-aqueous electrolyte secondary battery is used as a power source for electric equipment or the like, and also has started to be used as a power source of an electric vehicle (such as an EV or an HEV). Besides, there are demands for further improvement in characteristics of a non-aqueous electrolyte secondary battery, such as improvement in energy density, improvement in output density, and improvement in cycle characteristics.

For example, Patent Literature 1 discloses that, in order to obtain good battery characteristics, a positive electrode additive having a discharge capacity at a discharge potential lower than an average discharge potential of a positive electrode active material is added to a positive electrode, a negative electrode additive having a discharge potential higher than an average discharge potential of a negative electrode active material is added to a negative electrode, and the resultant battery is over-discharged at the time of discharge performed after initial charge.

### CITATION LIST

### Patent Literature

Patent Literature 1: JP 2013-197051 A

### SUMMARY

In a positive electrode containing a precedently reported positive electrode active material, particularly, a positive electrode active material having a high Ni content, charge-discharge efficiency in the first cycle is low, positive electrode regulation is easily caused, and a potential of the positive electrode at a last stage of the discharge of the battery tends to be abruptly lowered to a deep potential. In a potential lowering region where the potential of the positive electrode is thus abruptly lowered, the structure is largely degraded due to volume change, crystal structure change and the like of the positive electrode active material, and hence cycle characteristics are degraded.

An object of the present disclosure is to provide a non-aqueous electrolyte secondary battery having improved cycle characteristics by inhibiting a potential of a positive electrode from reaching a potential lowering region at a last stage of discharge of the battery.

A non-aqueous electrolyte secondary battery of the present disclosure comprises: a positive electrode comprising a positive electrode active material containing a lithium-containing transition metal oxide, and a lithium compound derived from an irreversible substance irreversibly reacting with lithium at a voltage lower than an average operating voltage of the positive electrode active material.

According to the present disclosure, a potential of the positive electrode is inhibited from reaching a potential lowering region at a last stage of discharge of the battery, and hence a non-aqueous electrolyte secondary battery having improved cycle characteristics can be provided.

### BRIEF DESCRIPTION OF DRAWINGS

FIGS. 1(A) and 1(B) illustrate charge-discharge curves, in which FIG. 1(A) illustrates a charge-discharge curve in the first cycle of a positive electrode containing a conventional positive electrode active material, and FIG. 1(B) illustrates a charge-discharge curve in the first cycle of a conventional non-aqueous electrolyte secondary battery.

FIGS. 2(A) and 2(B) illustrate charge-discharge curves, in which FIG. 2(A) illustrates a charge-discharge curve in the first cycle of a non-aqueous electrolyte secondary battery including a positive electrode containing (CₓF)ₙ, that is, an irreversible substance, and FIG. 2(B) illustrates a charge-discharge curve in the second and following cycles of the non-aqueous electrolyte secondary battery including the positive electrode containing (CₓF)ₙ, that is, an irreversible substance.

FIG. 3 is a schematic sectional view of a non-aqueous electrolyte secondary battery according to an exemplified embodiment.

FIG. 4 is a diagram illustrating results of DCR of batteries A1 to A4 of Examples 1 to 4.

### DESCRIPTION OF EMBODIMENTS

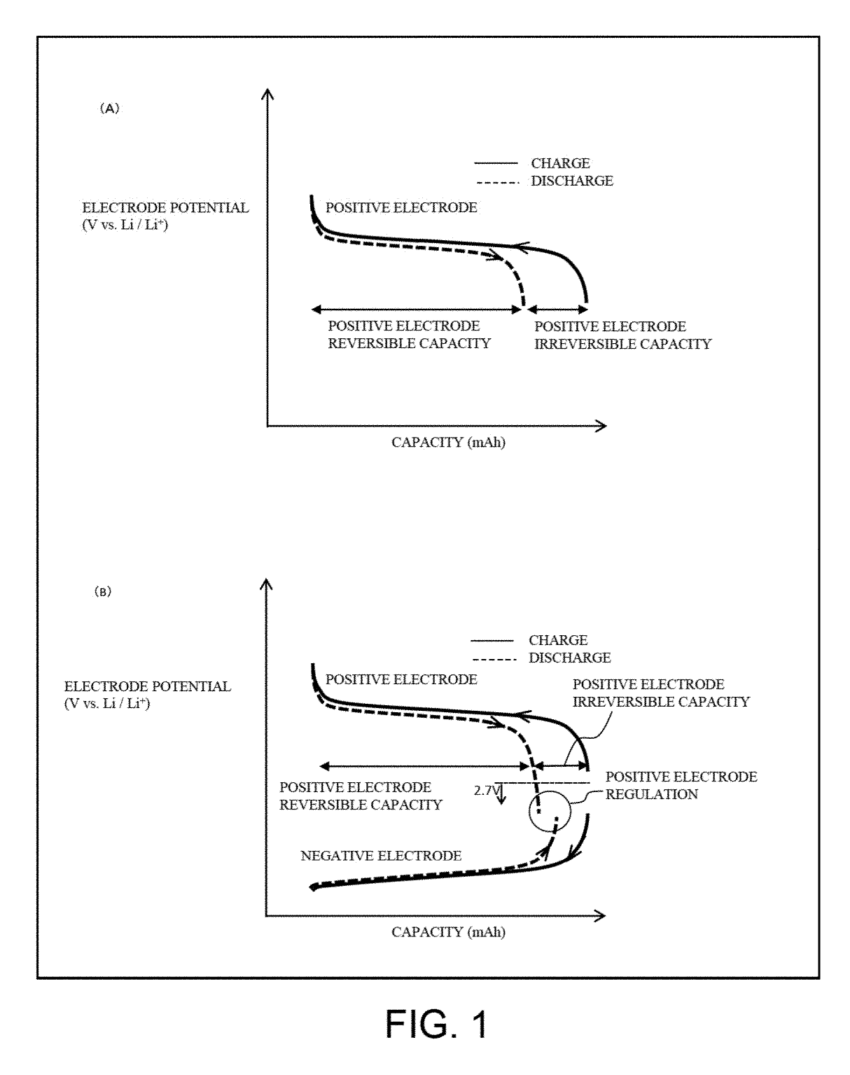

FIG. 1(A) illustrates a charge-discharge curve in the first cycle of a positive electrode containing a conventional positive electrode active material, and FIG. 1(B) illustrates a charge-discharge curve in the first cycle of a conventional non-aqueous electrolyte secondary battery. In the positive electrode containing a conventionally known positive electrode active material, particularly a positive electrode active material having a high Ni content, as illustrated in FIG. 1(A), there is a large charge-discharge capacity difference between charge and discharge in the first cycle at an average operating voltage (for example, 2.8 V to 4.3 V vs. Li/Li+) of the positive electrode usually employed as a battery. This charge-discharge capacity difference corresponds to irreversible capacity, and lithium ions corresponding to the irreversible capacity are lithium ions that have been released from the positive electrode in the charge but cannot be occluded in the discharge. A percentage of the discharge capacity to the charge capacity in the first cycle is usually designated as charge-discharge efficiency of the positive electrode.

As described above, a positive electrode containing a precedently reported positive electrode active material (particularly, a positive electrode active material having a high Ni content) has low charge-discharge efficiency, and therefore, in a usual non-aqueous electrolyte secondary battery, positive electrode regulation in which a positive electrode discharge capacity (a positive electrode reversible capacity) in the first cycle is smaller than a negative electrode discharge capacity in the first cycle is caused as illustrated in FIG. 1(B). In the positive electrode regulation, lithium corresponding to a capacity equal to or more than the positive electrode reversible capacity (lithium corresponding to the positive electrode irreversible capacity) is released from the negative electrode, and therefore, a potential of the positive electrode reaches a potential lowering region (of, for example, 2.7 V or less) that is lower than an average operating voltage (for example, 2.8 V to 4.3 V vs. Li/Li⁺) usually employed as a battery, resulting in causing structure degradation of the positive electrode active material. When the lithium corresponding to the capacity equal to or more than the positive electrode reversible capacity (excessive lithium) to be released from the negative electrode is not consumed on the side of the positive electrode in the first cycle, the lithium corresponding to the capacity equal to or more than the positive electrode reversible capacity (the lithium corresponding to the positive electrode irreversible capacity) remains in the negative electrode active material, and therefore, the positive electrode regulation is retained in the second and following cycles. Accordingly, the structure degradation of the positive electrode active material owing to the potential lowering region is continued, resulting in degrading cycle characteristics of the battery.

Therefore, the present inventors have made earnest studies, and as a result, have found that cycle characteristics can be improved by performing over-discharge after adding, to a positive electrode, an irreversible substance irreversibly reacting with lithium at a voltage lower than an average operating voltage of a positive electrode active material so as to form a lithium compound derived from the irreversible substance by reacting excessive lithium (lithium corresponding to a positive electrode irreversible capacity) remaining in a negative electrode active material with the irreversible substance.

Here, an example of the irreversible substance irreversibly reacting with lithium at a voltage lower than the average operating voltage of the positive electrode active material includes a fluorocarbon. The fluorocarbon is obtained by fluorinating a carbonaceous material, and is represented by general formula (CₓF)ₙ. Representative examples among these include (CF)ₙ and (C₂F)ₙ.

The fluorocarbon and the lithium performs the following irreversible reaction in a non-aqueous electrolyte solution:

(CₓF)ₙ+nLi⁺+ne⁻→nxC+nLiF

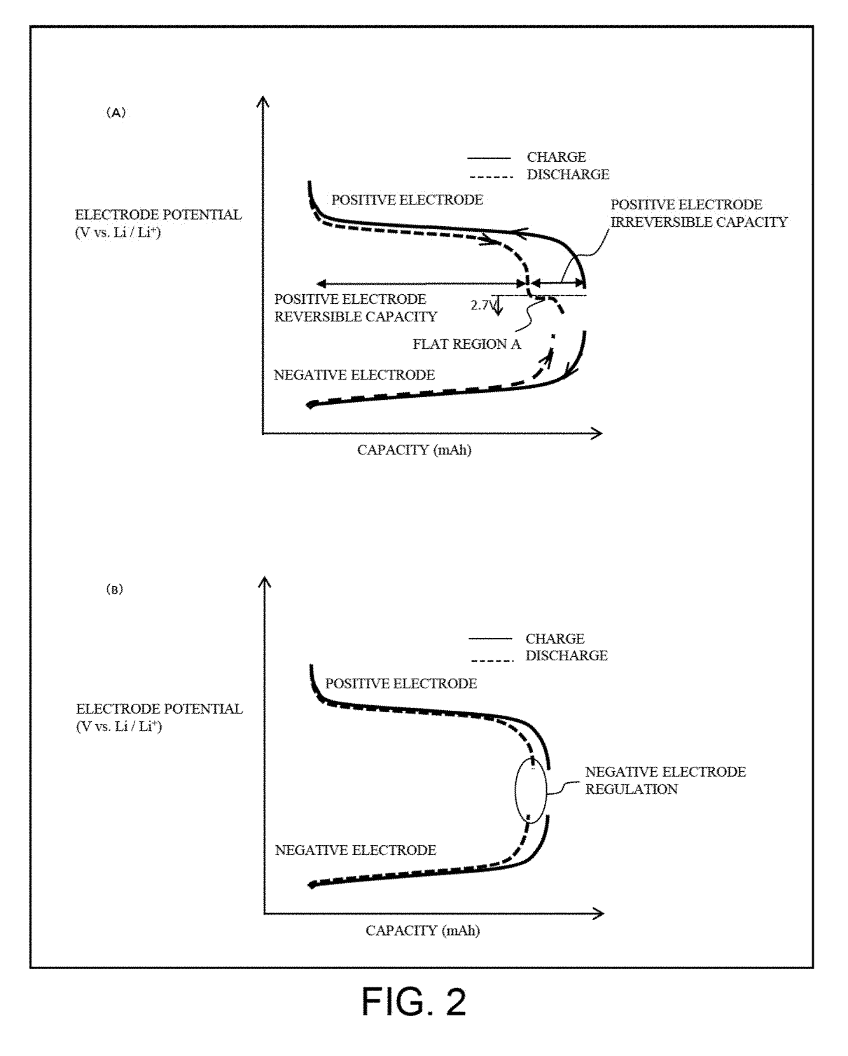

This reaction proceeds in a potential region (of, for example, 2.7 V or less) lower than an average operating voltage of the positive electrode. Accordingly, when the irreversible substance of (CₓF)ₙ is added to the positive electrode and over-discharge is performed, for example, in the discharge of the first cycle to a potential where the reaction proceeds, the excessive lithium (the lithium corresponding to the positive electrode irreversible capacity) remaining in the negative electrode active material reacts with the (CₓF)ₙ added to the positive electrode, and hence a flat region A illustrated in FIG. 2(A) is observed. As a result, the excessive lithium (the lithium corresponding to the positive electrode irreversible capacity) remaining in the negative electrode active material is fixed in the positive electrode as irreversible LiF (a lithium compound) in the discharge of the first cycle, and hence is not released from the positive electrode in the second and following cycles. In this manner, when the excessive lithium remaining in the negative electrode active material is consumed by the (CₓF)ₙ added to the positive electrode, the reaction of the positive electrode active material in the potential lowering region lower than the average operating voltage of the positive electrode is inhibited, so as to inhibit the structure degradation of the positive electrode active material. Then, since no excessive lithium remains in the negative electrode active material, in the charge-discharge of the second and following cycles, as illustrated in FIG. 2(B), negative electrode regulation in which the reversible capacity of the positive electrode is larger than the reversible capacity of the negative electrode, or a state where the reversible capacity of the positive electrode is substantially equivalent to the reversible capacity of the negative electrode can be caused. As a result, in the second and the following cycles, the discharge potential of the positive electrode is inhibited from lowering to the potential lowering region lower than the average operating voltage (for example, 2.8 V to 4.3 V vs. Li/Li⁺) usually employed as a battery, and therefore, the structure degradation of the positive electrode active material is inhibited, resulting in inhibiting the degradation of the cycle characteristics of the battery.

Now, an example of a non-aqueous electrolyte secondary battery according to one aspect of the present disclosure will be described. A drawing referred to in the description of an embodiment is schematically illustrated, and a dimensional ratio and the like of a composing element illustrated in the drawing may be different from that of an actual product in some cases.

<Structure of Non-Aqueous Electrolyte Secondary Battery>

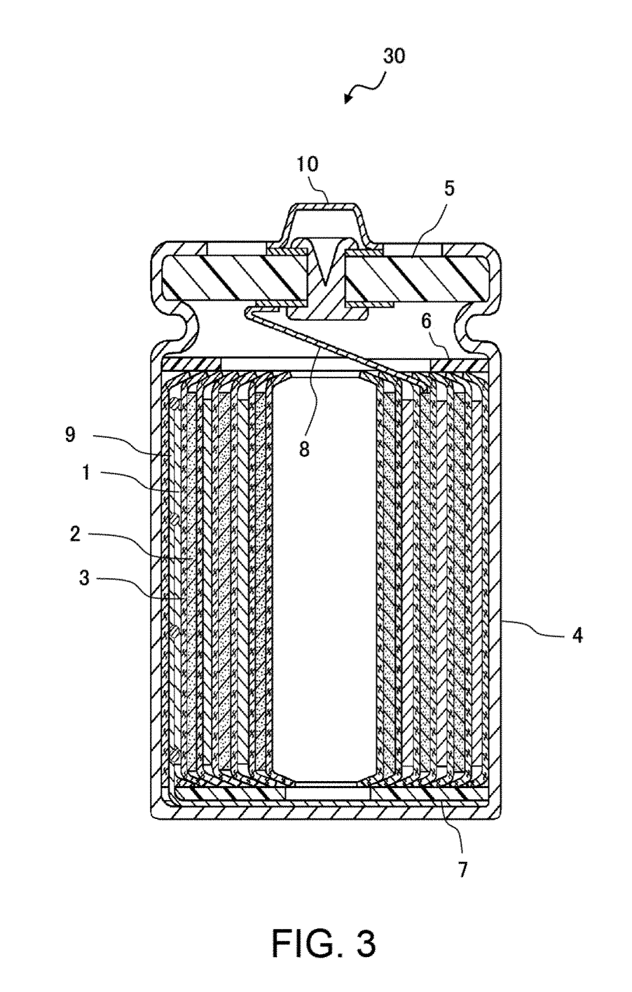

FIG. 3 is a schematic sectional view of a non-aqueous electrolyte secondary battery according to an exemplified embodiment. The non-aqueous electrolyte secondary battery 30 of FIG. 3 is a cylindrical battery, but the structure of the non-aqueous electrolyte secondary battery of the embodiment is not limited to this structure, and examples include a rectangular battery and a laminated battery.

The non-aqueous electrolyte secondary battery 30 of FIG. 3 includes a negative electrode 1, a positive electrode 2, a separator 3 disposed between the negative electrode 1 and the positive electrode 2, a non-aqueous electrolyte (an electrolyte solution), a cylindrical battery case 4, and a sealing plate 5. The non-aqueous electrolyte is injected into the battery case 4. The negative electrode 1 and the positive electrode 2 are wound up with the separator 3 disposed therebetween, so as to together form a wound electrode group together with the separator 3. At both ends along the lengthwise direction of the wound electrode group, an upper insulating plate 6 and a lower insulating plate 7 are attached, and the resultant is housed in the battery case 4. One end of a positive electrode lead 8 is connected to the positive electrode 2, and the other end of the positive electrode lead 8 is connected to a positive electrode terminal 10 provided on the sealing plate 5. One end of a negative electrode lead 9 is connected to the negative electrode 1, and the other end of the negative electrode lead 9 is connected to an inner bottom of the battery case 4. These leads and members are connected to each other through welding or the like. An open end of the battery case 4 is caulked to the sealing plate 5, and the battery case 4 is thus sealed.

<Positive Electrode>

The positive electrode 2 includes a positive electrode current collector of, for example, a metal foil or the like, and a positive electrode active material layer formed on the positive electrode current collector. As the positive electrode current collector, a foil of a metal that is stable in a positive electrode potential range, such as aluminum, a film including such a metal in a surface layer, or the like can be used.

The positive electrode active material layer contains a lithium-containing transition metal oxide, that is, a positive electrode active material, and the above-described lithium compound derived from the irreversible substance. The positive electrode active material layer preferably further contains a conductive material and a binder material.

[Lithium-Containing Transition Metal Oxide]

The lithium-containing transition metal oxide is not especially limited as long as it is a metal oxide containing lithium and a transition metal element. As a material has lower charge-discharge efficiency in the first cycle to easily cause positive electrode regulation, however, the effect of inhibiting the degradation of the cycle characteristics of the present embodiment is higher. In consideration of this, a lithium-containing transition metal oxide having a high Ni content is preferred, and in particular, a lithium-containing transition metal oxide represented by, for example, general formula of LiₐNiₓM₁₋ₓO₂ (wherein 0.9≤a≤1.2, 0.8≤x≤1, and M represents one or more elements selected from Co, Al and Mn) is more preferred. Specific examples include a Ni—Co—Mn-based lithium-containing transition metal oxide and a Ni—Co—Al-based lithium-containing transition metal oxide.

A molar ratio of Ni, Co and Mn in the Ni—Co—Mn-based lithium-containing transition metal oxide is, for example, 33:33:33, 50:20:30, 51:23:26, 55:20:25, 70:20:10, 70:10:20, or the like. In particular, from the viewpoint of improving the capacity, a molar ratio of Ni to a sum of moles of Ni, Co and Mn is preferably 33 or more, and from the viewpoint of the thermal stability, the molar ratio of Ni is preferably 60 or less.

A molar ratio of Ni, Co and Al in the Ni—Co—Al-based lithium-containing transition metal oxide is, for example, 82:15:3, 82:12:6, 80:10:10, 80:15:5, 87:9:4, 88:9:3, 91:6:3, 95:3:2, or the like. In particular, from the viewpoint of improving the capacity, a molar ratio of Ni to a sum of moles of Ni, Co and Al is preferably 82 or more, and from the viewpoint of the thermal stability, a molar ratio of Al is preferably 3 or more.

Additional elements of the lithium-containing transition metal oxide are not limited to Ni, Co, Mn and Al, but the metal oxide may contain another additional element. Examples of another additional element include alkali metal elements excluding lithium, transition metal elements excluding Mn, Ni and Co, alkaline earth metal elements, group 12 elements, group 13 elements and group 14 elements. Specific examples of such another additional element include zirconium (Zr), boron (B), magnesium (Mg), titanium (Ti), iron (Fe), copper (Cu), zinc (Zn), tin (Sn), sodium (Na), potassium (K), barium (Ba), strontium (Sr) and calcium (Ca). Among these, Zr is preferred. When Zr is contained, the crystal structure of the resultant lithium-containing transition metal oxide is stabilized, and it is presumed that durability at a high temperature of the positive electrode active material layer and the cycle characteristics are improved. A content of Zr in the lithium-containing transition metal oxide is preferably 0.05 mol % or more and 10 mol % or less, more preferably 0.1 mol % or more and 5 mol % or less, and particularly preferably 0.2 mol % or more and 3 mol % or less with respect to a total amount of metals excluding Li.

<Lithium Compound Derived from Irreversible Substance>

The lithium compound derived from the irreversible substance is obtained by discharging (over-discharging), to a voltage lower than the average operating voltage of the positive electrode active material, the non-aqueous electrolyte secondary battery including the positive electrode containing the irreversible substance. As described above, excessive lithium present in the negative electrode is consumed by the irreversible substance to generate the lithium compound derived from the irreversible substance, and thus, the structure degradation of the positive electrode active material and the degradation of the cycle characteristics of the battery can be inhibited.

Discharging conditions to be employed in forming the lithium compound derived from the irreversible substance are not especially limited as long as the discharge is performed with a discharge cut-off voltage set to be smaller than a difference between a potential at which the irreversible substance reacts with lithium and a potential at which lithium is released from the negative electrode, and from the viewpoint that the excessive lithium present in the negative electrode active material can be efficiently consumed by the irreversible substance, constant current discharge is preferably performed.

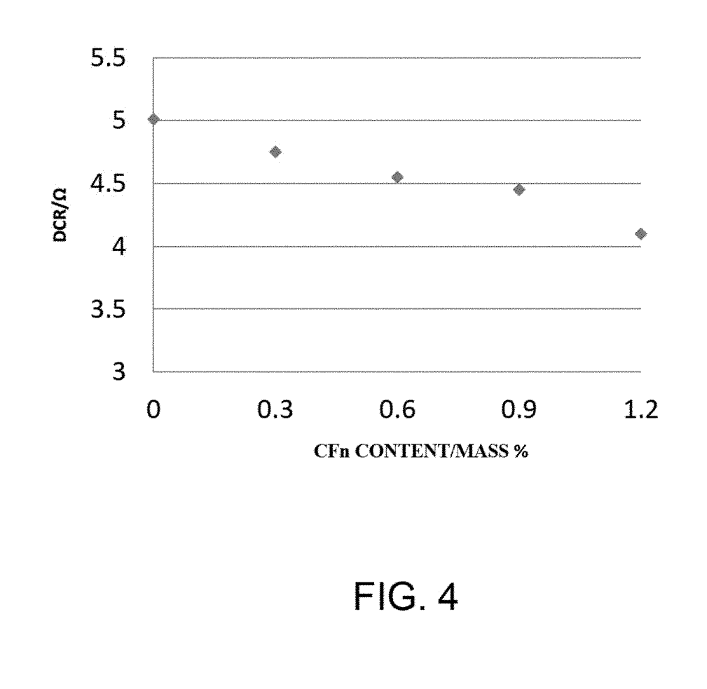

The irreversible substance is not especially limited as long as it is a substance irreversibly reacting with lithium at a voltage lower than the average operating voltage of the positive electrode active material, and examples include a fluorocarbon represented by general formula (CₓF)ₙ, and a metal oxide, such as tin oxide, iron oxide, nickel oxide or cobalt oxide. Among these, a fluorocarbon is preferred. Carbon is generated through a reaction between a fluorocarbon and lithium (see the above-described reaction formula). The thus generated carbon improves the conductivity of the positive electrode, and hence, resistance polarization of the positive electrode can be reduced as illustrated in FIG. 4.

A fluorocarbon is synthesized by, for example, heating a carbon material at 300° C. to 600° C. in a fluorine gas atmosphere. Alternatively, a fluorocarbon is synthesized by, for example, heating a carbon material together with a fluorine compound at about 100° C. Examples of the carbon material to be used as a raw material include thermal black, acetylene black, furnace black, vapor grown carbon fiber, pyrolytic carbon, natural graphite, artificial graphite, mesophase microbead, petroleum coke, coal coke, petroleum-based carbon fiber, coal-based carbon fiber, charcoal, activated carbon, glassy carbon, rayon-based carbon fiber and PAN-based carbon fiber.

A content of the irreversible substance to be added to the positive electrode is preferably an amount with which the excessive lithium present in the negative electrode active material can be consumed to cause the negative electrode regulation. Specifically, although varied depending on the type and the amount of the negative electrode active material used, and the type and the amount of the positive electrode active material used, the content of the irreversible substance to be added to the positive electrode is, in a state before generating the lithium compound, preferably in a range of 0.1% by mass or more and 1% by mass or less, and more preferably in a range of 0.3% by mass or more and 0.9% by mass or less with respect to the amount of the positive electrode active material. When the content of the irreversible substance is less than 0.1% by mass, it may be difficult to cause the negative electrode regulation in the resultant battery in some cases, and when the content exceeds 1% by mass, resistance increase, capacity decrease and the like of the battery may be affected in some cases. Assuming that (CF)ₙ is used, the content of the irreversible substance in terms of a content of the lithium compound derived from the irreversible substance is preferably in a range of 0.08% by mass or more and 0.84% by mass or less, and more preferably in a range of 0.25% by mass or more and 0.75% by mass or less with respect to the amount of the positive electrode active material. Incidentally, when (CF)n is used, a reaction molar ratio is obvious from the reaction formula, and hence, a percentage by mass (a concentration) of the lithium compound to be generated can be introduced from the amount of the added fluorocarbon through calculation based on the molecular weights (CF:31 and LiF: 26).

[Conductive Material]

Examples of the conductive material include carbon materials such as carbon black, acetylene black, Ketchen black and graphite. One of these may be singly used, or two or more of these may be used in combination.

[Binder Material]

Examples of the binder material include fluorine-based resins such as polytetrafluoroethylene (PTFE) and polyvinylidene fluoride (PVdF), polyacrylonitrile (PAN), polyimide-based resins, acrylic-based resins and polyolefin-based resins. Alternatively, any of such a resin may be used together with carboxymethylcellulose (CMC) or a salt thereof (such as CMC-Na, CMC-K, CMC-NH₄ or a partially neutralized salt thereof), polyethylene oxide (PEO) or the like. One of these may be singly used, or two or more of these may be used in combination.

<Negative Electrode>

The negative electrode 1 includes a negative electrode current collector of, for example, a metal foil or the like, and a negative electrode active material layer formed on the negative electrode current collector. As the negative electrode current collector, a foil of a metal that is stable in a negative electrode potential range, such as copper, a film including, in a surface layer, a metal stable in the negative electrode potential range such as copper, or the like can be used. The negative electrode active material layer preferably contains a binder material in addition to a negative electrode active material capable of occluding/releasing lithium ions. As the binder material, PTFE or the like can be used in the same manner as in the positive electrode, and a styrene-butadiene copolymer (SBR) or a modified product thereof is preferably used. The binder material may be used together with a thickener such as CMC.

As the negative electrode active material, for example, natural graphite, artificial graphite, lithium, silicon, carbon, tin, germanium, aluminum, lead, indium, gallium, lithium alloy, carbon and silicon in which lithium has been precedently occluded, or an alloy or a mixture of any of these can be used.

<Separator>

As the separator 3, a porous sheet or the like having ion permeability and an insulating property is used. Specific examples of the porous sheet include a microporous thin film, a woven fabric, and a non-woven fabric. As a material of the separator, olefin-based resins such as polyethylene and polypropylene, cellulose and the like are preferred. The separator may be a laminate including a cellulose fiber layer and a thermoplastic resin fiber layer of an olefin-based resin or the like. Alternatively, it may be a multi-layered separator including a polyethylene layer and a polypropylene layer, or a separator having a surface coated with a resin such as an aramid-based resin can be used.

<Non-Aqueous Electrolyte>

The non-aqueous electrolyte contains a non-aqueous solvent and an electrolyte salt dissolved in the non-aqueous solvent.

The electrolyte salt is preferably a lithium salt. As the lithium salt, any of those generally used as a supporting salt in a conventional non-aqueous electrolyte secondary battery can be used. Examples include LiBF₄, LiClO₄, LiPF₆, LiAsF₆, LiSbF₆, LiAlCl₄, LiSCN, LiCF₃SO₃, LiC(C₂F₅SO₂), LiCF₃CO₂, Li(P(C₂O₄)F₄), Li(P(C₂O₄)F₂), LiPF₆₋ₓ(CnF₂ₙ₊₁)ₓ (wherein 1≤x≤6, and n represents 1 or 2), LiB₁₀Cl₁₀, LiCl, LiBr, LiI, chloroborane lithium, lower aliphatic lithium carboxylate, Li₂B₄O₇, borates such as Li(B(C₂O₄)₂) [lithium bisoxalato borate (LiBOB)] and Li(B(C₂O₄)F₂), imide salts such as LiN(FSO₂)₂ and LiN(C₁F₂ₗ₊₁SO₂)(CₘF₂ₘ₊₁SO₂) {wherein 1 and m represent an integer of 1 or more}, and LiₓP_{y}O_{z}F_{α} (wherein x represents an integer of 1 to 4, y represents 1 or 2, z represents an integer of 1 to 8, and α represents an integer of 1 to 4). Among these, LiPF₆, LiₓP_{y}O_{z}F_{α} (wherein x represents an integer of 1 to 4, y represents 1 or 2, z represents an integer of 1 to 8, and α represents an integer of 1 to 4) and the like are preferred. Examples of LiₓP_{y}O_{z}F_{α} include lithium monofluorophosphate and lithium difluorophosphate. One of these lithium salts may be singly used, or a mixture of a plurality of these may be used.

Examples of the non-aqueous solvent include cyclic carbonates, chain carbonates and carboxylic acid esters. Specific examples include cyclic carbonates such as ethylene carbonate (EC), propylene carbonate (PC), butylene carbonate and vinylene carbonate; chain carbonates such as dimethyl carbonate (DMC), methyl ethyl carbonate (MEC), diethyl carbonate (DEC), methyl propyl carbonate, ethyl propyl carbonate and methyl isopropyl carbonate; chain carboxylic acid esters such as methyl propionate (MP), ethyl propionate, methyl acetate, ethyl acetate and propyl acetate; and cyclic carboxylic acid esters such as γ-butyrolactone (GBL) and γ-valerolactone (GVL).

The non-aqueous electrolyte may contain a halogen-substituted product. Examples of the halogen-substituted product include a fluorinated cyclic carbonate such as 4-fluoroethylene carbonate (FEC), a fluorinated chain carbonate, and a fluorinated chain carboxylic acid ester such as methyl 3,3,3-trifluoropropionate (FMP).

### EXAMPLES

The present disclosure will now be more specifically described in detail with reference to examples and comparative examples, and it is noted that the present disclosure is not limited to the following examples.

### Example 1

[Preparation of Positive Electrode Active Material]

A nickel-cobalt-aluminum composite oxide was prepared by burning a nickel-cobalt-aluminum composite hydroxide obtained by mixing and coprecipitating NiSO₄, CoSO₄ and Al₂(SO₄)₃ in an aqueous solution. Next, the thus obtained composite oxide and lithium carbonate were mixed using a grinding mortar. A mixing ratio (a molar ratio) between lithium and nickel-cobalt-aluminum, that is, a transition metal, in the resultant mixture was 1.1:1.0. The mixture was burned in air at 900° C. for 10 hours and the resultant was crushed to obtain a Ni—Co—Al-based lithium-containing transition metal oxide (a positive electrode active material). The thus obtained lithium transition metal oxide was subjected to elemental analysis by ICP atomic emission spectroscopy, resulting in finding that a molar ratio of the respective elements Ni, Co and Al with respect to the whole transition metal was 82:15:3.

[Irreversible Substance]

A fluorocarbon obtained by fluorinating carbon by heating at 300 to 600° C. in a fluorine gas atmosphere was used as an irreversible substance.

[Preparation of Positive Electrode]

The positive electrode active material, the irreversible substance (the fluorocarbon), carbon black and polyvinylidene fluoride (PVDF) were mixed in a mass ratio of 100:0.3:1:0.9. To the thus obtained mixture, N-methyl-2-pyrrolidone (NMP) was added as a dispersant, and the resultant was kneaded to prepare a positive electrode mixture slurry. Next, the positive electrode mixture slurry was coated on an aluminum foil used as a positive electrode core, and the thus coated film was dried to form a positive electrode active material layer on the aluminum foil. The positive electrode core on which the positive electrode active material layer had been thus formed was cut into a prescribed size, the resultant was rolled out, and an aluminum tab was attached thereto to obtain a positive electrode.

[Preparation of Negative Electrode]

Graphite, carboxymethylcellulose (CMC) and styrene-butadiene rubber (SBR) were mixed in a mass ratio of 100:1:1, and water was added thereto. The resultant was stirred using a mixer (manufactured by PRIMIX Corporation, T.K. Hivis Mix) to prepare a negative electrode mixture slurry. Next, the negative electrode mixture slurry was coated on a copper foil used as a negative electrode core, the thus coated film was dried, and the resultant was rolled out by a rolling roller. Thus, a negative electrode including negative electrode active material layers formed on both surfaces of a copper foil was prepared.

[Preparation of Non-Aqueous Electrolyte]

Ethylene carbonate (EC), methyl ethyl carbonate (MEC) and dimethyl carbonate (DMC) were mixed in a volume ratio of 30:30:40. In the thus obtained mixed solvent, LiPF₆ was dissolved to a concentration of 1.2 mol/litter, and vinylene carbonate was further dissolved in a concentration of 0.3% by mass.

[Production of Battery]

An aluminum lead and a nickel lead were respectively attached to the positive electrode and the negative electrode, a polyethylene microporous film was used as a separator, and the positive electrode and the negative electrode were spirally wound up with the separator disposed therebetween to produce a wound electrode body. The electrode body was housed in a battery case main body in a bottomed cylindrical shape, the non-aqueous electrolyte was poured thereinto, an opening of the battery case main body was sealed by a gasket and a sealing body, and thus, a cylindrical non-aqueous electrolyte secondary battery was produced.

[Charge-Discharge in First Cycle]

The battery produced as described above was used to perform charge-discharge once at a temperature of 25° C. at a charge-discharge current of 11 mA with a charge cut-off voltage set to 4.2 V and a discharge cut-off voltage set to 1.5 V. The resultant battery was designated as a battery A1 of Example 1.

### Example 2

A battery was produced in the same manner as in Example 1 except that the positive electrode active material, the irreversible substance (the fluorocarbon), carbon black and polyvinylidene fluoride (PVDF) were mixed in a mass ratio of 100:0.6:1:0.9. The resultant battery of Example 2 was designated as a battery A2.

### Example 3

A battery was produced in the same manner as in Example 1 except that the positive electrode active material, the irreversible substance (the fluorocarbon), carbon black and polyvinylidene fluoride (PVDF) were mixed in a mass ratio of 100:0.9:1:0.9. The resultant battery of Example 3 was designated as a battery A3.

### Example 4

A battery was produced in the same manner as in Example 1 except that the positive electrode active material, the irreversible substance (the fluorocarbon), carbon black and polyvinylidene fluoride (PVDF) were mixed in a mass ratio of 100:1.2:1:0.9. The resultant battery of Example 4 was designated as a battery A4.

### Comparative Example 1

A battery was produced in the same manner as in Example 1 except that the irreversible substance was not added. The resultant battery of Comparative Example 1 was designated as a battery B1.

### Comparative Example 2

The irreversible substance was not added to a positive electrode, and in producing a negative electrode, graphite, the irreversible substance, carboxymethylcellulose (CMC) and styrene-butadiene rubber (SBR) were mixed in a mass ratio of 100:0.3:1:1. A battery was produced in the same manner as in Example 1 except for the above. The resultant battery of Comparative Example 2 was designated as a battery B2.

### Comparative Example 3

The irreversible substance was not added to a positive electrode, and in producing a negative electrode, graphite, the irreversible substance, carboxymethylcellulose (CMC) and styrene-butadiene rubber (SBR) were mixed in a mass ratio of 100:0.6:1:1. A battery was produced in the same manner as in Example 1 except for the above. The resultant battery of Comparative Example 3 was designated as a battery B3.

[Confirmation of Lithium Compound Derived from Irreversible Substance]

In a discharge curve in the first cycle of the positive electrode of each of the batteries A1 to A4 of Examples 1 to 4, a flat region was observed in the vicinity of 2.0 V. Besides, the battery of each of Examples 1 to 4 was decomposed before and after the charge-discharge to take out the positive electrode, and the positive electrode was subjected to SEM-EDS measurement, resulting in finding the following: Merely in the positive electrode taken out after the charge-discharge, a state where carbon generated through the above-described irreversible reaction and fluorine were adjacent to each other or a state where unreacted fluorocarbon was present as a homogeneous mixture was found, which result accords with a ratio between fluorine and carbon estimated based on the amount of the added fluorocarbon. It can be said, based on this result, that the lithium compound derived from the irreversible substance was formed in the positive electrodes of Examples 1 to 4. Besides, it is presumed that the state where carbon generated through the above-described irreversible reaction and fluorine are adjacent to each other or the state where unreacted fluorocarbon is present as a homogeneous mixture can be found also in EPMA measurement in the same manner as in the SEM-EDS measurement.

On the other hand, in a discharge curve of the positive electrode of the battery B1 of Comparative Example 1, a flat region was not observed in the vicinity of 2.0 V, and even when the positive electrode was subjected to the SEM-EDS measurement, the state where carbon and fluorine were adjacent to each other or the presence of the homogeneous mixture was not found. In a charge curve in the first cycle of the negative electrode of each of the batteries B2 to B3 of Comparative Examples 2 to 3, a flat region was observed in the vicinity of 3.5 V. Besides, the battery of each of Comparative Examples 2 to 3 was decomposed before and after the charge-discharge to take out the negative electrode, and the negative electrode was subjected to the SEM-EDS measurement, resulting in finding the following: Merely in the negative electrode taken out from the battery after the charge-discharge, the state where carbon generated through the above-described irreversible reaction and fluorine were adjacent to each other or the state where unreacted fluorocarbon was present as a homogeneous mixture was found, which result accords with a ratio between fluorine and carbon estimated based on the amount of the added fluorocarbon. It can be said, based on these results, that the lithium compound derived from the irreversible substance was formed in the negative electrodes of Comparative Examples 2 to 3.

[Cycle Characteristics]

Each of the batteries A1 to A4 of Examples 1 to 4 and the batteries B1 to B3 of Comparative Examples 1 to 3 produced as described above was used for performing a charge-discharge cycle test 30 times at a temperature of 25° C. at a charge-discharge current of 11 mA with a charge cut-off voltage set to 4.2 V and a discharge cut-off voltage set to 2.5 V.

With a capacity degradation rate after the 30 cycles of the battery B1 of Comparative Example 1 used as a reference (100%), the capacity degradation rate after the 30 cycles of each of the batteries A1 to A4 of Examples 1 to 4 and the batteries B2 to B3 of Comparative Examples 2 to 3 was calculated. The results are shown in Table 1.

TABLE 1

| | Positive Electrode | Negative Electrode | |
|---|---|---|---|
| | (CF)n Content | (CF)n Content | Capacity |
| | (Amount of Li | (Amount of Li | Degradation Rate |
| Battery | Compound)/mass % | Compound)/mass % | (after 30 cycles) |
| A1 | 0.3 (0.25) | — | 83% |
| A2 | 0.6 (0.50) | — | 67% |
| A3 | 0.9 (0.75) | — | 83% |
| A4 | 1.2 (1.00) | — | 87% |
| B1 | — | — | 100% |
| B2 | — | 0.3 (0.25) | 100% |
| B3 | — | 0.6 (0.50) | 100% |

As is obvious from the results shown in Table 1, in the batteries B2 to B3 in which the fluorocarbon was added to the negative electrode to form fluorinated lithium derived from the fluorocarbon in the negative electrode, an effect of improving the cycle characteristics was not exhibited. On the contrary, in the batteries A1 to A4 of Examples 1 to 4 in which the fluorocarbon was added to the positive electrode to form fluorinated lithium derived from the fluorocarbon in the positive electrode, the capacity degradation rate was lower than that of the battery B1 of Comparative Example 1 in which the fluorocarbon was not added, and thus, it can be said that the cycle characteristics were improved. In particular, the content of the fluorocarbon is preferably in a range of 0.3% by mass or more and 0.9% by mass or less with respect to the amount of the positive electrode active material, and in terms of the content of the lithium compound, is preferably in a range of 0.25% by mass or more and 0.75% by mass or less with respect to the amount of the positive electrode active material.

[Measurement of DCR]

DCR of each of the batteries A1 to A4 of Examples 1 to 4 and the battery B1 of Comparative Example 1 was measured under the following conditions. The results are shown in FIG. 4.

OCV Adjustment: Constant current charge was performed at a temperature of 25° C. and a current density of 20 mA up to 3.8 V (vs. Li/Li+), and constant voltage charge was performed at a constant voltage of 3.8 V (vs. Li/Li+) until a current density of 5 mA was obtained.

DCR Measurement

After the OCV adjustment, discharge was performed at a temperature of 25° C. at a current density of 27.6 mA, and a voltage before the discharge and a voltage 10 seconds after starting the discharge were measured. The measured voltages were applied to the following formula to calculate initial DCR of each battery.

DCR(Ω)=(voltage before discharge−voltage 10 sec. after starting discharge)/current value

As is obvious from the results shown in FIG. 4, when the fluorocarbon is added to the positive electrode, carbon is generated through the reaction between the fluorocarbon and lithium at the time of the over-discharge performed in initial charge-discharge (see the above-described reaction formula). Since the thus generated carbon improves the conductivity of the positive electrode, the resistance polarization of the positive electrode can be reduced. In consideration of this characteristic of fluorocarbon, the substance to be added to the positive electrode to irreversibly react with lithium at a voltage lower than the average operating voltage of the positive electrode active material is preferably fluorinated graphite.

### INDUSTRIAL APPLICABILITY

The present disclosure can be applied to a non-aqueous electrolyte secondary battery.

### REFERENCE SIGNS LIST

1 negative electrode
2 positive electrode
3 separator
4 battery case
5 sealing plate
6 upper insulating plate
7 lower insulating plate
8 positive electrode lead
9 negative electrode lead
10 positive electrode terminal
30 non-aqueous electrolyte secondary battery

1. A non-aqueous electrolyte secondary battery, comprising:
a positive electrode comprising a positive electrode active material containing a lithium-containing transition metal oxide, and a lithium compound derived from an irreversible substance irreversibly reacting with lithium at a voltage lower than an average operating voltage of the positive electrode active material,
wherein the positive electrode active material contains a lithium-containing transition metal oxide represented by general formula LiₐNiₓM₁₋ₓO₂, wherein 0.9≤a≤1.2, 0.8≤x≤1, and M represents one or more elements selected from Co, Al and Mn.

2. The non-aqueous electrolyte secondary battery according to claim 1, wherein the irreversible substance contains a fluorocarbon.

3. The non-aqueous electrolyte secondary battery according to claim 1, wherein a content of the irreversible substance is in a range of 0.1% by mass or more and 1% by mass or less with respect to an amount of the positive electrode active material.
